(19) United States
(12) Patent Application Publication
(10) Pub. No.: US 2006/0036458 A1
(43) Pub. Date: Feb. 16, 2006

(54) Data processing system and method for commodity value management

(75) Inventors: David Thursfield, Cheltenham (GB); Cindy Jefferson, Detroit, MI (US); Chris Ray, Billericay (GB); Dan Fortunato, Sylvania Township, OH (US); Janice Lin, Plymouth, MI (US); Lee Kremzier, Farmington Hills, MI (US); Edward Blanch, Bloomfield Hills, MI (US); William Lutton, Danbury (GB)

Correspondence Address: BROOKS KUSHMAN P.C./FGTL, 1000 TOWN CENTER, 22ND FLOOR, SOUTHFIELD, MI, 48075-1238, US

(73) Assignee: Ford Motor Company, Dearborn, MI (US)

(21) Appl. No.: 10/919,063

(22) Filed: Aug. 16, 2004

(51) Int. Cl. G06Q 99/00

(52) U.S. Cl. 705/1

(57) ABSTRACT

Embodiments include receiving into one or more computer databases a plurality of cost factors associated with supplying a commodity for vehicle manufacturing. A zero-based cost estimate for the commodity is calculated based on one or more of the plurality of cost factors. A current cost for the commodity is received into the one or more computer databases, and a cost variance between the current cost for the commodity and the zero-based cost estimate is calculated. One or more actions for reducing the cost variance may be received into one or more of the computer databases. The zero-based cost estimate for the commodity, the current cost for the commodity, the cost variance, and the one or more actions for reducing the cost variance may be displayed on one or more interactive user interfaces. A cross-functional team including representatives from engineering, purchasing and finance may implement the methodology.

### BACKGROUND OF THE INVENTION

1. Field of the Invention

The present invention relates generally to data processing including financial, business practice, management or cost/price determination (USPC 705). In particular, the present invention relates to a computer data processing system and method for commodity value management.

2. Background Art

Conventional organizational structures for large-scale manufacturing companies are not technologically or procedurally adapted for cross-functional management of commodity sourcing. Although engineers, cost estimators and buyers all rely upon one another to procure the right commodities for manufacturing, these individuals are typically focused on their own commodity-related responsibilities. As a result, these individuals may not be fully aware of, or aligned with, the enterprise's overall sourcing strategies and value targets. Further, these individuals may not freely exchange their respective sourcing knowledge and experience, and may not be held accountable for attaining the enterprise's overall sourcing goals (e.g., negotiated price reductions, design improvements and innovations for reducing cost and increasing quality, etc.).

Integrating these cross-functional souring participants and their respective knowledge contributions in a systematic and technological manner, however, would enable a more comprehensive understanding of corporate sourcing strategy, and a broader alignment thereto. Further, a resulting centralized knowledge base for cross-functional sourcing information would help to identify and decrease business-related and technological inefficiencies in commodity sourcing, thereby increasing an enterprise's ability to meet its sourcing objectives.

### SUMMARY OF THE INVENTION

One objective of the present invention is to provide an improved and technology-enhanced methodology for conducting commodity sourcing activities or “value management” within an enterprise, including input from and cooperation of a cross-functional team of business representatives and suppliers.

Another objective of the present invention is to increase commodity “value.” Generally, commodity value may be increased by (i) decreasing cost for a given commodity without sacrificing function, (ii) increasing commodity function without increasing commodity cost, or both. Of course, trade-offs between commodity cost and function may occur. Ultimately, an increase in commodity “value” will result in the delivery of a higher quality product to the customer base at a lower cost.

Another objective of the present invention is to provide an efficient and easy-to-use data processing system for receiving and monitoring the status and progress of the commodity sourcing activities in an automated fashion. This aspect of the present invention provides an enterprise with an accurate and easy-to-understand graphical representation of commodity sourcing status, cost-reduction opportunities, etc.

Another objective of the present invention is to engage suppliers in the commodity sourcing process. In particular, this includes learning from suppliers as well as teaching suppliers about the most efficient and highest quality manufacturing products and processes available among the supply base. By engaging suppliers, best-in-class manufacturing and delivery processes may be identified and attained. In addition, inefficiencies in the commodity supply base may be identified and reduced or eliminated.

Another objective of the present invention is to provide a methodology for (i) establishing and understanding a zero-based cost estimate for a commodity, (ii) calculating a variance between a zero-based cost estimate for the commodity and current supplier pricing for the commodity, and (iii) taking defined actions to reduce or eliminate the variance. Such actions may include supplier price negotiation, refinement or change of supplier materials or processes, or introducing different suppliers.

Aspects and embodiments of the present invention may be implemented in a variety of industries that include commodity or material purchasing. The present invention is well-suited, for example, for product assembly and manufacturing industries such as vehicle manufacturing.

Embodiments of the present invention include a computer-implemented method and system for commodity value management in vehicle manufacturing. These embodiments include receiving into one or more computer databases data representing a plurality of cost factors associated with supplying a commodity for vehicle manufacturing. The cost factors may include supplier manufacturing data, competitive benchmark data, and/or market analysis data.

A zero-based cost estimate for the commodity is calculated based on one or more of the plurality of cost factors. The zero-based cost estimate may by calculated based on one or more best-in-class cost factors. A current cost for the commodity is received into the one or more computer databases, and a cost variance between the current cost for the commodity and the zero-based cost estimate is calculated.

One or more actions for reducing the cost variance may be received into one or more of the computer databases. The actions for reducing the cost variance may include supplier price negotiation, supplier process improvement, and/or involving a new supplier.

The zero-based cost estimate for the commodity, the current cost for the commodity, the cost variance, and the one or more actions for reducing the cost variance may be displayed on one or more user interfaces. A target commodity cost may also be received into the database(s) and displayed.

Upon implementing the actions for reducing the cost variance, a revised current cost for the commodity may be received into the computer database. A revised cost variance between the revised cost for the commodity and the zero-based cost estimate may then be calculated and displayed.

The user interface(s) may include a chart displaying the zero-based estimate, the current cost for the commodity, and the cost variance. The chart may include one or more user-selectable regions, the selection of which causes a region for receiving user-defined commodity cost data to be automatically displayed.

In a preferred embodiment, a cross-functional team implements the methodology. The team may include one or more engineering representatives, one or more purchasing representatives, and one or more finance representatives.

The above objects, advantages and embodiments of the present invention, as well as other objects, features, advantages and embodiments of the present invention are readily apparent from the following detailed description of the preferred embodiments, when taken in conjunction with the drawings thereof. Notably, neither the written description of the preferred embodiments of the present invention or corresponding drawings thereof are intended to limit the scope of the present invention. Those of ordinary skill in the relevant art will recognize that various modifications and adaptations may be made to the preferred embodiments within the spirit and scope of the present invention.

### BRIEF DESCRIPTION OF THE DRAWINGS

FIG. 1 is a block flow diagram illustrating an overview of a preferred TVM methodology 10 in accordance with one aspect of the present invention;

FIG. 2 is a table disclosing a variety of example opportunities for improving commodity value;

FIG. 3 is a block diagram illustrating various TVM team roles, and their respective interactivity in accordance with a preferred embodiment of the present invention;

FIG. 4 is a chart disclosing example activities and an example time-line for involving suppliers in the TVM process;

FIG. 5 is a system diagram illustrating a suitable computing arrangement for implementing aspects of the present invention;

FIG. 6 is a graphical illustration of a zero-based estimate and variance generated in accordance with a preferred embodiment of the present invention;

FIG. 7a is an interactive graphical user interface for displaying a graphical comparison between a target variance reduction for a calendar year and a current variance reduction in accordance with a preferred embodiment of the present invention;

FIG. 7b is an interactive graphical user interface for displaying a respective cost impact of planned and committed variance reduction opportunities for a commodity by supplier for a given calendar year in accordance with a preferred embodiment of the present invention;

FIG. 7c is an interactive graphical user interface for displaying a commercial variance breakdown for a commodity in accordance with a preferred embodiment of the present invention;

FIG. 7d is an interactive graphical user interface for displaying quantitative impact of future variance reducing activities over future calendar years as projected against a current market based high-confidence variance or gap in accordance with a preferred embodiment of the present invention;

FIG. 7e is an interactive graphical user interface for displaying the quantitative impact of zero-based estimate variance or gap closure actions as projected across future years by supplier in accordance with a preferred embodiment of the present invention; and

FIG. 8 is a graphical user interface for interactively inputting or revising parameters automatically processed and displayed in accordance with a preferred embodiment of the present invention.

### DETAILED DESCRIPTION OF THE PREFERRED EMBODIMENT(S)

Team Value Management

Team Value Management (“TVM”) is a cross-functional team-oriented and technology-based business process for understanding, managing and maximizing “value” in the manufacturing industry. According to one embodiment of the present invention, “value” includes (but is not limited to) product performance, customer satisfaction, product quality, product functionality, product design, product sourcing/logistics, and competitive leverage in the manufacturing industry.

Table 1 sets forth an example set of business principles and practices that may be utilized or advanced by the TVM methodology and system.

TABLE 1
Example TVM Business Principles

Provides input to forward and current model
target setting processes
Single, shared commodity-based cross-
functional cost metric
Committed team members with aligned
objectives to Supervisor level
Co-located TVM meeting facilities with
benchmark hardware
Best internal and external practices used to
achieve benchmark commodity cost and value
Supplier participation to develop joint-
benefit solutions

TVM Framework

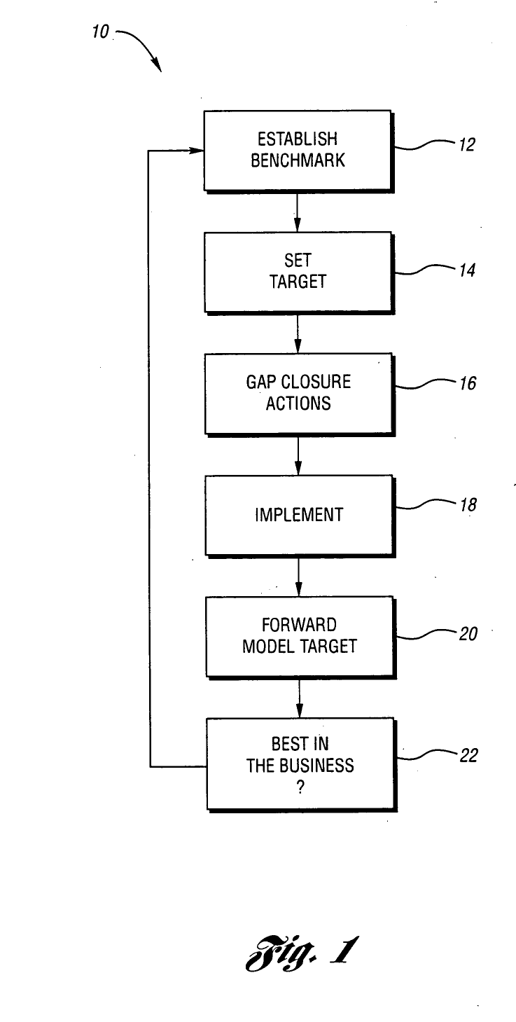

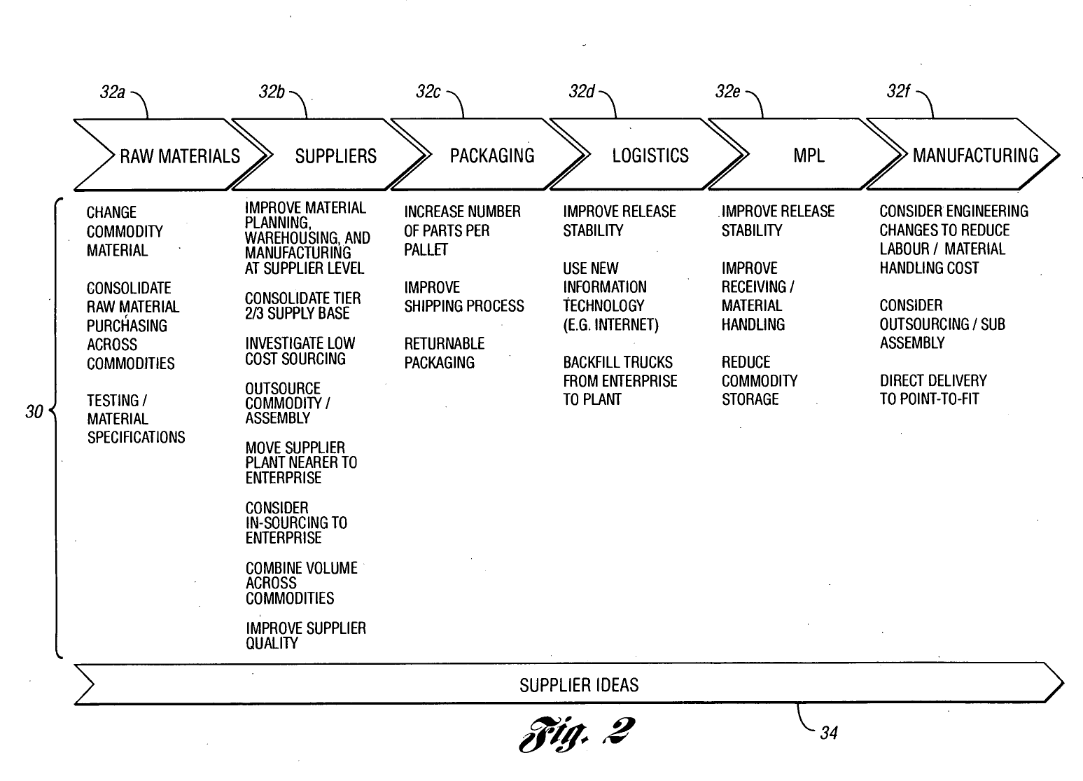

FIG. 1 is a block flow diagram illustrating a high-level overview of a preferred TVM methodology 10 in accordance with one aspect of the present invention. Notably, FIG. 1 is not intended to limit the scope of the present invention. To the contrary, the teachings of FIG. 2 may be modified or otherwise adapted to best-fit a particular implementation or application of the present invention.

The preferred TVM methodology includes six general steps 12-22. However, the present invention does not require all aspects of the TVM methodology to be implemented. Nor does the present invention require the steps to be implemented according to the preferred embodiments shown herein.

Establish Benchmark—12

This aspect of the TVM methodology seeks to determine whether a commodity is competitive in “value.” More specifically, the inquiry may involve comparing absolute commodity pricing, assessing competitiveness of commodity design and function, and understanding detailed external benchmarks for the commodity.

One aspect of this TVM step includes calculating a zero-based cost estimate (“ZBE”) for the commodity. A ZBE is a best-case cost for a commodity, assuming best-in-class manufacturing conditions—even where those conditions cannot currently be provided by a single supplier.

The ZBE for a commodity may be calculated based on industry-wide best-in-class manufacturing process and business information. Activity-based manufacturing cost information may also be utilized in the calculation.

As an alternative or supplement to the ZBE, competitive benchmarking information and market analysis data may also be utilized to calculate a best-case cost for a commodity. Preferably, benchmarking information and/or market analysis data is used to validate or correct the ZBE for a commodity.

Another aspect of this TVM step includes calculating a variance between the ZBE cost for the commodity, and the manufacturer's current or anticipated sourcing cost for the commodity. Typically, a positive variance will exist (i.e., the current commodity sourcing cost is higher than the ZBE). This is because few suppliers implement all available best-in-class manufacturing, activity and business processes. In instances where the variance is negative, however, the ZBE may or may not be corrected to match the current commodity cost.

Another aspect of this TVM step includes determining and evaluating current/anticipated supplier manufacturing and business practices. Typically, this inquiry of supplier manufacturing and business practices will include and/or require supplier participation and disclosure.

Once a supplier's current manufacturing and business practices have been identified, they can be compared to the industry-wide best-in-class processes and practices to identify and explain any positive variance between the current cost for the commodity and the ZBE. Once the reasons behind the variance are identified and explained, opportunities for process/practice improvement may be identified.

There may be a wide variety of reasons that a current commodity cost exceeds the industry-wide ZBE for the commodity. For example, the supplier may not be purchasing raw material at a competitive price. The supplier may be paying an excessive labor rate. The supplier may have manufacturing process inefficiencies, or excessive SG&A. The supplier may also be charging excess profit. In other instances, there may be no explanation for a variance. Notably, the process of identifying variance sources is based primarily on objective industry-wide knowledge.

Table 2 is an example activities roadmap for the Establish Benchmark step of the TVM process. The content and arrangement of Table 2 may be adapted to best-fit a particular implementation of the present invention.

TABLE 2

| | |
|---|---|
| Preliminary | Gather existing data |
| analysis | Carry out analysis to isolate easily |
| | identifiable causes of gap-to-benchmark |
| | Recommended preliminary sources to |
| | analyze: price, volume and supplier |
| | data; vehicle to vehicle comparison; |
| | market test data; quality issues, etc. |
| Commodity cost | Estimate piece cost to produce (zero |
| estimate | based) |
| | Check how commodity estimate may have |
| | changed over time |
| | Understand what is driving the changes |
| | (e.g. labor, currencies, tier 2 issues, |
| | etc.) |
| Benchmark | Identify all potential benchmarks |
| selection | within price and quality range |
| | (external, pan-brand, cross |
| | carline/series) |
| | Adjust to volume, brand factors to |
| | obtain “apples with apples” comparison |
| | Decide on which competitor to use for |
| | benchmark analysis |
| Competitor | Determine “best-in-class” benchmarks |
| benchmarking | (with suppliers support), among |
| | competition |
| | Ensure analysis considers quality, |
| | cost, customer satisfaction and |
| | functionality |
| | Utilize information obtained to |
| | establish industry benchmark |
| Design | Conduct physical and specifications |
| comparison | review/tear down of benchmark |
| | commodities to understand differences in |
| | design |
| Supplier | Interview suppliers to understand all |
| interviews | aspects of design differences on |
| | competitor parts. |
| | Understand, from supplier, impact of |
| | differences on cost, quality and |
| | functionality |
| Value chain and | Identify elements of tier 1 supplier |
| supplier cost | internal cost structure |
| analysis | Identify elements of tier 2-3 value |
| | chain |
| | Supplier costing systems to be |
| | understood |
| | Suppliers to provide outstanding value |
| | chain/cost breakdown data |
| | Analyze the tier 1, 2, 3 supplier |
| | material sourcing pattern to identify |
| | the following opportunities: logistics |
| | cost reduction; business financing; |
| | lower cost manufacturing locations |
| Supplier | Obtain process description as well as |
| benchmarking | financial data from all key suppliers. |
| | Conduct supplier site visits |
| | Identify best practices |
| | Understand what is driving best |
| | performance |
| Gap analysis | Access “gap” to identified benchmarks |
| completed | |
| CHECKPOINT: | DELIVERABLES: |
| Understand gap- | Gap-to-benchmark analysis output |
| to-benchmark | TVM operational review group/TVM |
| (design/ | steering group review checkpoint |
| commercial | Approval required to pass through |
| drivers of gap) | checkpoint |
| | Dialogue with management on findings |
| | at this point |

Set Target—14

This aspect of the TVM methodology seeks to define opportunities for increasing commodity value through sourcing. One aspect of this process step includes reviewing and understanding current business requirements or “top down” sourcing targets, and the sourcing initiatives and strategies necessary to meet those targets. Top-down commodity targets include customer satisfaction, quality, functionality and cost. Preferably, implications of the sourcing targets and associated initiatives are discussed with line management in connection with this process step.

Another aspect of this process step includes identifying sourcing opportunities for delivering more than the “top down” commodity targets. Put another way, the “top down” commodity targets may be required to maintain an acceptable delivery “value” for given commodity and model. Further sourcing opportunities may be available, however, for delivering more commodity value than the business currently requires. For example, additional supplier manufacturing process improvements or other supplier cost-cutting opportunities may be available to reduce any variance between the current commodity price and the ZBE.

Preferably, a “stretch” target is also defined during this process step. A stretch target may include short-term, medium-term and long-term plans for increasing commodity value beyond the current benchmarks (e.g., ZBE, commodity quality, etc.).

During the target setting process step, it is additionally preferred that target and benchmark data implications are discussed with TVM leadership champions, TVM operational review groups, and/or TVM steering groups. This discussion may include reaching agreement as to the targets, their achievability, and the initiatives for reaching those targets.

Table 3 is an example activities roadmap for the Set Target step of the TVM process. The content and arrangement of Table 3 may be adapted to best-fit a particular implementation of the present invention.

TABLE 3

| Suggested | |
|---|---|
| actions | Activities |
| Target review | Review top-down target |
| | Understand current initiatives/work to |
| | deliver target |
| | Understand strategy to get supplier to |
| | target |
| | Review implications with line |
| | management |
| Benchmark review | Review benchmark data to understand |
| | potential opportunities |
| | Access achievability of target given |
| | benchmark data. |
| | Are we: far from benchmark?; at |
| | benchmark?; beyond benchmark? |
| | Understand the challenge of achieving |
| | (defining) benchmark |
| Target setting | Discuss target and benchmark data |
| | implications with TVM leadership |
| | champions. TVM operational review group. |
| | Develop proposed TVM team target and |
| | approach to deliver. |
| | Review and agree target with TVM |
| | leadership champions, TVM operational |
| | review group, TVM steering group. |

Gap Closure Actions—16

This step of the TVM methodology seeks to identify the particular actions necessary to meet the value targets and improve commodity value and competitiveness. This process step may be divided into two primary aspects. One aspect seeks to determine whether current supplier processes and technologies may be improved. This aspect may include assessing immediate commercial and physical opportunities to improve commodity value based on the current commodity design. This aspect may also include considering design changes that may lead to further commodity value improvements.

Supplier opportunities may include increasing supplier productivity, increasing supplier volume, evaluating alternative suppliers for the commodity, and selecting the best supplier for the commodity. Ultimately, suppliers will be motivated to adopt such opportunities in exchange for an ongoing business relationship with the manufacturer.

Another primary aspect of this process step seeks to determine whether any new business opportunities can be explored to additionally improve commodity value and competitiveness. New business opportunities may include new manufacturing and sourcing technologies that may be implemented, and value chain opportunities.

FIG. 2 discloses a variety of example opportunities 30 for improving commodity value. Notably, the opportunities disclosed in FIG. 2 are examples and are not intended to limit the scope of the present invention. For purposes of illustration, opportunities are divided among a variety of different opportunity categories (e.g. raw materials 32a, suppliers 32b, packaging 32c, logistics 32d, MP&L 32e, manufacturing 32f, etc.). Of course, other opportunities 30 and opportunity categories 32 may exist. In addition suppliers may propose their own ideas 34 for improving commodity value.

Engineering changes may be made at the manufacturer and supplier levels to reduce supplier production and/or logistics costs. In some instances, cost may be reduced by changing materials without sacrificing quality. Overall quality and functionality may also be improved. Technology trends may be evaluated to determine how they might impact the design, cost and performance of the commodity. Alternative commodity suppliers may be manufacturing the commodities with new and/or improved manufacturing processes and techniques yielding a higher quality to cost ratio. Competitor technologies and processes should also be evaluated for their effectiveness and, if better than current technologies and processes, for their implementability.

Value chain cost-saving opportunities may include improving manufacturing processes at the manufacturer and supplier levels, and improving transport, packaging, warehousing and delivery processes. Additionally, make/buy and supplier purchasing strategies may be reviewed for improvement opportunities in asset utilization.

Suggested actions for this process step include conducting an opportunity assessment workshop, reviewing improvement opportunities from previous gap closure initiatives, conducting supplier visits and line-walks, reviewing manufacturing processes, encouraging supplier input on engineering-based opportunities, and creating a database of actions to seize value opportunities in the commodity base.

Table 4 discloses an example activities roadmap for the Gap Closure step of the TVM process. The content and arrangement of Table 4 may be adapted to best-fit a particular implementation of the present invention.

TABLE 4

| Suggested | |
|---|---|
| actions | Activities |
| Opportunity | Hold one core event with suppliers and |
| assessment | other functions to develop an opportunity |
| workshop | list. |
| | Aid selection of all ideas for |
| | implementation including high probability |
| | projects, ideas and competitor ideas. |
| | (Use facilitator if necessary). |
| | Establish first sight targets |
| Review results | Review output of previous initiatives |
| of previous | and workshops used during other |
| initiatives | performance improvement projects |
| Use existing | Decide which tools and processes can be |
| tool to | used to identify new opportunities(e.g. |
| discover new | CAB/teardown, VA/VE, value chain analysis, |
| opportunities | supplier benchmarking, lean deployment |
| | diagnostics etc.) |
| Get suppliers' | Get input from supplier on savings |
| input on | opportunities based on engineering changes |
| engineering | Encourage supplier to suggest |
| based | engineering changes |
| opportunities | Ask supplier about historical issues |
| | with design ideas implementation and |
| | suggestions on how to overcome/develop |
| | solutions |
| Supplier | Visit supplier plant to review supplier |
| visits or line | technology/processes/logistics |
| walks | Conduct supplier site deep-dives and |
| | line walks |
| Review | Team to review the logistics/in plant |
| manufacturing | activities to identify cost reduction |
| process | ideas (e.g. design, commercial, |
| | manufacturing/logistics/packaging, |
| | supplier park effectiveness, etc.) |
| Hold workshop | Get input from program PD in future |
| with program | vision of commodity |
| team | |
| Create actions | Collate all existing opportunities and |
| database | all ideas identified to crease database |

Implementation—18

This step of the TVM methodology seeks to implement the identified opportunities for improving commodity value. One aspect of this process step includes defining a prioritized action plan. Actions may be prioritized according to opportunity magnitude, speed of implementation, customer quality impact, difficulty of implementation, etc.

Another aspect of this step includes assigning ownership/accountability, specific tasks and deadlines for implementation of commodity opportunities.

Another aspect of this process step includes calculating expected “results” for implementing the selected opportunities. Results may be financial, quality, and functionality-based.

Table 5 discloses an example activities roadmap for the Implementation step of the TVM process. The content and arrangement of Table 5 may be adapted to best-fit a particular implementation of the present invention.

TABLE 5

| Suggested actions | Activities |
|---|---|
| Design and | Develop initial design concept and |
| technology | review with all affected areas to |
| implementation | develop necessary work plan actions and |
| actions | agree resource requirements |
| | Log in action database |
| Commercial | Identify actions required to |
| implementation | implement total cost opportunities |
| actions | Develop work plan and agree task |
| | assignments |
| | Log in action database |
| Total cost | Identify actions required to |
| implementation | implement total cost opportunities |
| actions | Contact point person within |
| | enterprise (e.g., MP&L etc.) for |
| | implementation |
| | Agree resourcing and responsibilities |
| | Log in action database and tracking |
| | process |
| New business | Identify actions required and whom |
| opportunity | from enterprise and supplier needs to |
| implementation | be involved |
| actions | Hold workshop to define action plan, |
| | roles and responsibilities |
| | Agree resourcing and responsibilities |
| | Log in action database |
| Implementation | Ensure all actions identified and |
| planning and | logged in database |
| prioritization | Agree timing for delivery of |
| | opportunities |
| | Prioritize and agree task assignments |
| Assign roles and | Ensure all implementation aspects |
| responsibilities | documented and the names of key |
| | implementors identified and agreed |
| | Ensure all required management |
| | approvals received |
| | Identify obstacles encountered |
| Business equation | Cost opportunities: |
| | establish detailed cost save |
| | establish investment cost |
| | opportunities |
| | establish resource requirement/ |
| | investment/tarr |
| | formulate other commercial and |
| | business considerations |
| | develop proposed introduction/time |
| | obtain supplier sign-off |
| CHECKPOINT: | DELIVERABLES: |
| Implementation | TVM operational review group |
| plan | checkpoint - implementation planning |
| | Action summary chart (ABC chart) |
| | Quarterly reviews |
| | Operational review team dialogue with |
| | team champions |

Forward Model Target—20

This step of the TVM methodology seeks to increase commodity competitiveness on future products. One aspect of this process step includes defining a plan for meeting forward model brand and business requirements (e.g., customer satisfaction, functionality, quality, cost, etc.). Another aspect of this process step includes defining commodity inputs to forward program targets (e.g. “bottom-up” inputs). Yet another aspect of this process step includes assessing whether the forward model brand and business requirements are achievable—determining whether suppliers are prepared to deliver what will be required for forward models.

Table 6 is an example activities roadmap for the Forward Model Target step of the TVM process. The content and arrangement of Table 6 may be adapted to best-fit a particular implementation of the present invention.

TABLE 6

| Suggested | |
|---|---|
| Actions | Activities |
| Forward model | Workshop with forward model team to |
| workshop | understand commodity requirements/vision |
| Implications | Workshop with PD, purchasing and |
| workshop | suppliers to discuss implications of |
| | requirements and assess feasibility |
| Implications | Assessment of requirements based on |
| assessment | commodity plans, TVM commodity knowledge |
| | and workshop input. |
| Target inputs | Determine appropriate, future, bottom |
| | up targets as input for commodity teams. |
| | Ensure inputs include a clear |
| | description of assumptions regarding |
| | requirements |

Best in the Business—22

This step of the TVM methodology seeks to reflect upon the other TVM process steps to determine their effectiveness and successfulness. One aspect of this process step includes determining the results the TVM team has generated to date. Results-to-date include financial benefits and non-financial benefits. Additionally, a determination of whether the TVM process is improving supplier relationships may be made.

Another aspect of this process step includes determining what long-term value the TVM team is generating. This determination helps to ensure that all value opportunities have been identified, implemented, and results recorded for future TVM implementations.

Additionally, a future focus may be defined for meeting and exceeding future commodity requirements: future opportunities for quality improvement, functionality improvement, and cost reduction. A plan for modifying value targets over time may also be developed during this process step.

Table 7 is an example activities roadmap for the Best In The Business step of the TVM process. The content and arrangement of Table 7 may be adapted to best-fit a particular implementation of the present invention.

TABLE 7

| Suggested | |
|---|---|
| Actions | Activities |
| Result | Track and report financial/non-financial |
| reporting | results of all implementation actions |
| | Collect feedback on processes and |
| | solutions to improve, streamline and |
| | enforce results |
| Opportunities | Update opportunity database with |
| database | achieved benefits, roadblocks, etc. |
| Supplier | Get feedback from supplier to improve |
| feedback | supplier relationship and involvement to |
| | TVM |
| | Report potential roadblocks |
| Commodity | Provide input into commodity business plan |
| business plan | and commodity strategy to ensure TVM team |
| | knowledge is captured |
| Program | Discuss further opportunities with |
| planning | program organization |
| | Get clear vision of future developments |
| | and requirements |
| | Discuss future model design |
| | specifications |

TVM Team

According to a preferred embodiment of the present invention, a TVM team for implementing aspects of the TVM methodology is composed of one or more cross-functional business representatives. Preferably, the business functions include at least engineering, purchasing and cost-estimating. Preferably, the team members comprise, at least, one or more commodity buyers, one or more engineers, and one or more cost estimators.

A corporate governance process may be implemented to monitor the TVM teams progress and remove any roadblocks the TVM team faces in reaching its sourcing targets.

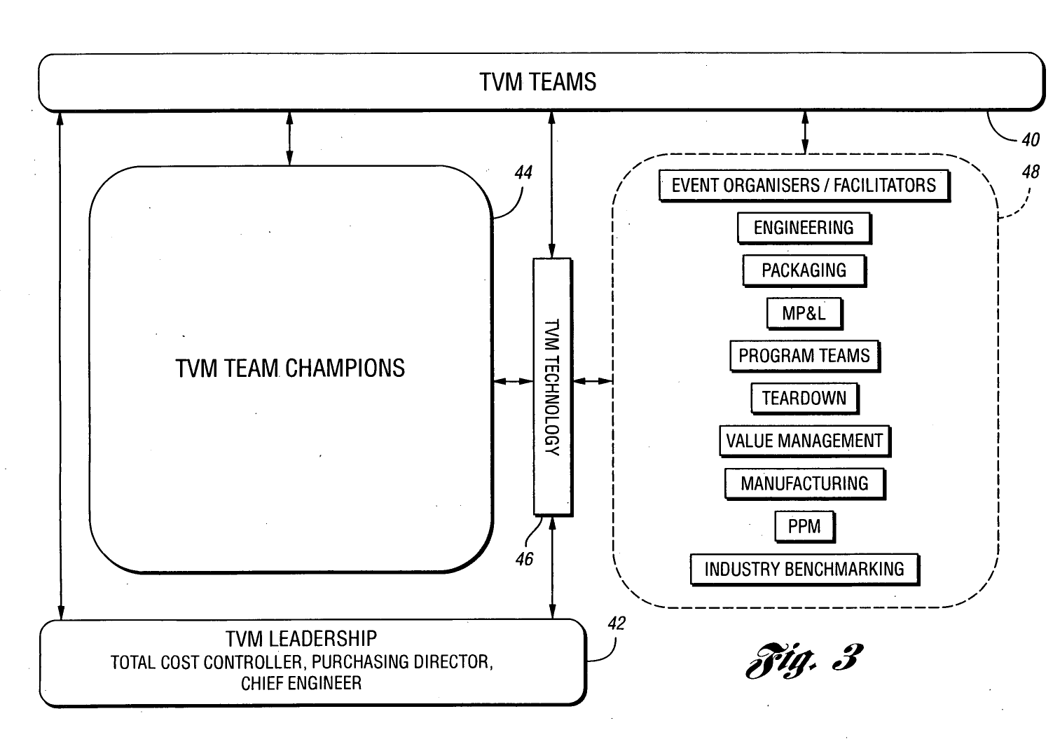

FIG. 3 is a block flow diagram illustrating the interplay between the TVM team and other aspects of the enterprise. As described above, each TVM team 40 preferably comprises one or more commodity-focused representatives from the engineering, finance and purchasing department of the enterprise for cross-functional commodity value management. TVM teams 40 interact with TVM leadership 42 (e.g. cost controller, purchasing director, chief engineer, etc.), TVM team champions 44, TVM technology 46 and a plurality of related or impacted aspects of the enterprise 44 (e.g., program teams, MP&L representatives, package engineering representatives, manufacturing representatives, engineering, etc.).

Supplier Involvement

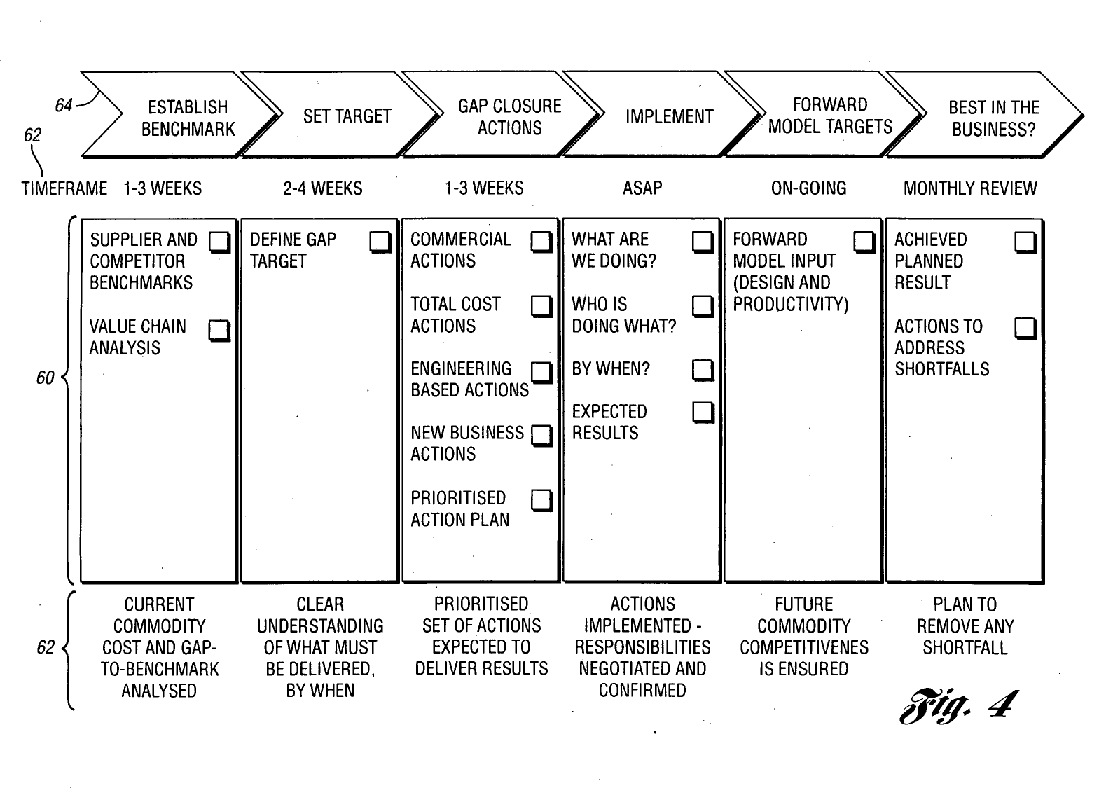

As described in greater detail above, supplier involvement in various aspects of the TVM process is preferred. FIG. 4 is a chart disclosing example supplier-related activities 60 and an example time-line 62 for involving suppliers in the TVM process. For purposes of illustration, supplier-related activities are divided among the different aspects of the overall TVM process described in greater detail above. Region 66 describes preferred results for each activity category.

TVM Technology

At various instances within the TVM process, the TVM teams and others involved (see FIG. 3) utilize and rely on a variety of TVM applications to manage the TVM process and results. In accordance with a preferred embodiment, application software is provided for managing commodity-specific data including the current supply base of a commodity, annual and historical turnover for the supply base, competitive commodity-specific data, etc. An interface is provided for calculating and graphically displaying a zero-based estimate for a commodity, including a graphical cost breakdown for the components of the zero-based estimate and any variance between the zero-based estimate and the current supplier price for the commodity. Application software manages planned and current actions to improve commodity value (i.e. reduce cost through supplier negotiations/design changes, or design changes to improve quality), as well as the monetary and/or qualitative status or progress of those actions.

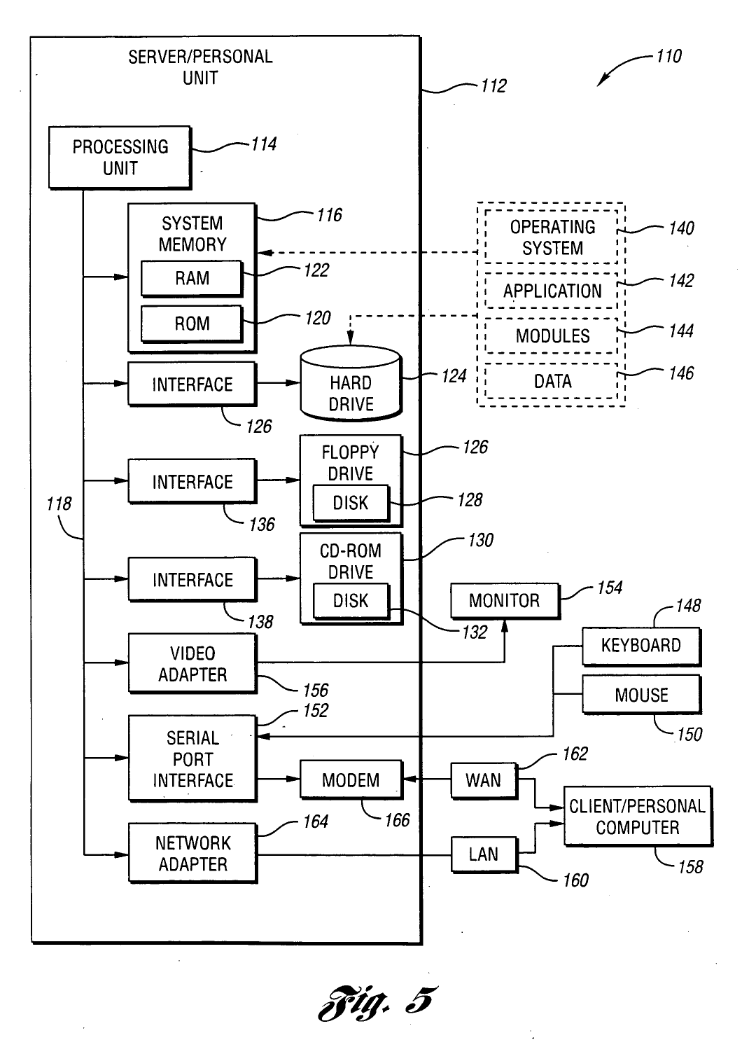

FIG. 5 and its associated description are intended to provide a brief, general description of suitable computing environments for implementing aspects of the present invention. Notably, FIG. 5 is not intended to limit the scope of the present invention. To the contrary, the teachings of FIG. 5 may be modified or otherwise adapted to best-fit a particular implementation or application of the present invention.

According to one embodiment, the system comprises a stand-alone personal computing environment. According to another embodiment, the system comprises a networked computer environment having a typical server-client configuration. Notably, a plurality of computing environments are understood by those skilled in the art of computing architecture and may be configured for implementing the present invention.

Computer system 110 comprises a server or personal computer 112 including a processing unit 114, a system memory 116 and a system bus 118 that interconnects various system components including the system memory 116 to the processing unit 114. The system bus 118 may comprise any of several types of bus structures including a memory bus or memory controller, a peripheral bus, and a local bus using a bus architecture such as PCI, etc. The system memory includes read only memory (ROM) 120 and random access memory (RAM) 122. A basic input/output system (BIOS), containing the basic routines that help to transfer information between elements within the computer 112, such as during start-up, is stored in ROM 120. The computer 112 further includes a hard disk drive 124, a magnetic disk drive (floppy drive, 126) to read from or write to a removable disk 128, and an optical disk drive (CD-ROM Drive, 130) for reading a CD-ROM disk 132 or to read from or write to other optical media. The hard disk drive 124, magnetic disk drive 126, and optical disk drive 130 are connected to the system bus 118 by a hard disk drive interface 134, a magnetic disk drive interface 136 and an optical drive interface 138, respectively. The drives and their associated computer-readable media provide nonvolatile storage of data, data structures, computer-executable instructions (program code such as dynamic link libraries, and executable files), etc. for the computer 112. Although the description of computer-readable media above refers to a hard disk, a removable magnetic disk and a CD, it can also include other types of media that are readable by a computer, such as magnetic cassettes, flash memory cards, digital video disks, Bernoulli cartridges, and the like.

A number of program modules may be stored in the drives and RAM 122, including an operating system 140, one or more application programs 142, other program modules 144, and program data 146. A user may enter commands and information into the computer 112 through a keyboard 48 and pointing device, such as a mouse 150. Other input devices (not shown) may include a microphone, dictaphone, scanner, or the like. These and other input devices are often connected to the processing unit 114 through a serial port interface 152 that is coupled to the system bus, but may be connected by other interfaces, such as a parallel port, game port or a universal serial bus (USB). A monitor 154 or other type of display device is also connected to the system bus 118 via an interface, such as a video adapter 156. In addition to the monitor, the computer may include other peripheral output devices (not shown), such as speakers and a printer.

In a networked configuration, there are several client computers 158 having a similar architecture to computer 112 and configured to operate as a client to computer 112 configured to operate as a server. The logical connections depicted in FIG. 5 between server computer 112 and any client computer 158 include (but are not limited to) a local area network (LAN) 160 and a wide area network (WAN) 62. Such networking environments are commonplace in offices, enterprise-wide computer networks, intranets and the Internet.

When used in a LAN networking environment, the server computer 112 is connected to the local network 160 through a network interface or adapter 164. When used in a WAN networking environment, the server computer 112 typically includes a modem 166 or other means for establishing communications over the wide area network 162, such as the Internet. The modem 166, which may be internal or external, is connected to the system bus 118 via the serial port interface 152. In a networked environment, program modules depicted relative to the server computer 112, or portions of them, may be stored in a remote memory storage device (not shown).

Application software described herein may be programmed in a plurality of computer languages including but not limited to C/C++, Visual C/C++, C#, Visual Basic, Java, XML, HTML, etc. Operating system platforms upon which the application software may run include Unix, Solaris, MS Windows, Linux, etc. Those of ordinary skill in the art recognize that a wide variety of operating systems and application programming languages may be utilized to program and execute functionality described herein.

FIG. 6 is a graphical illustration of a zero-based estimate and variance generated in accordance with a preferred embodiment of the present invention. User input defines parameters including a zero-based-estimate 120 for manufacturing/supplying a given commodity (e.g. $10.00), and a plurality of cost elements 122 comprising the variance 202 (e.g. $6.00) between the zero-based-estimate 120 and the purchase price for the commodity 204 (e.g. $16.00). Cost elements comprising the variance 202 are preferably displayed, as shown, with varying color or hash marks, each having a corresponding legend 206. Preferably, the legend displays the respective contribution to the variance each element is responsible for. Elements of the variance may include costs that are not included in the ZBE (e.g., packaging, supplier ED&T, supplier tooling, etc.), and costs that were included in the ZBE, but which exceeded the corresponding ZBE allowance (e.g., unexplained gaps, SG&A differential, overhead differential, etc.).

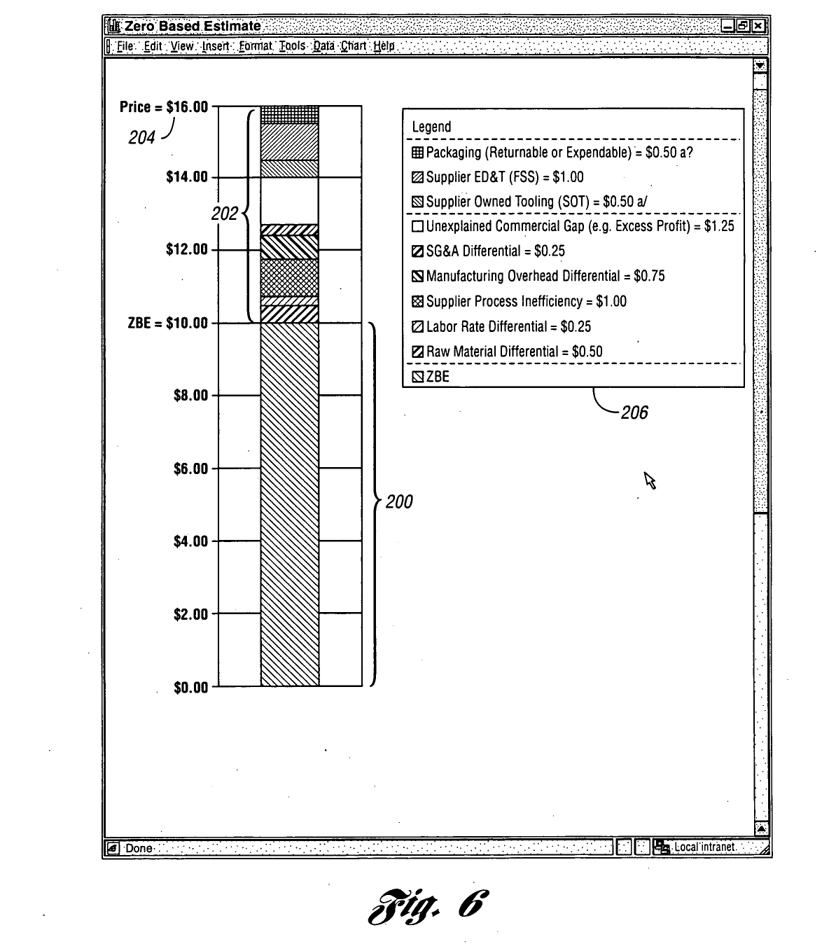

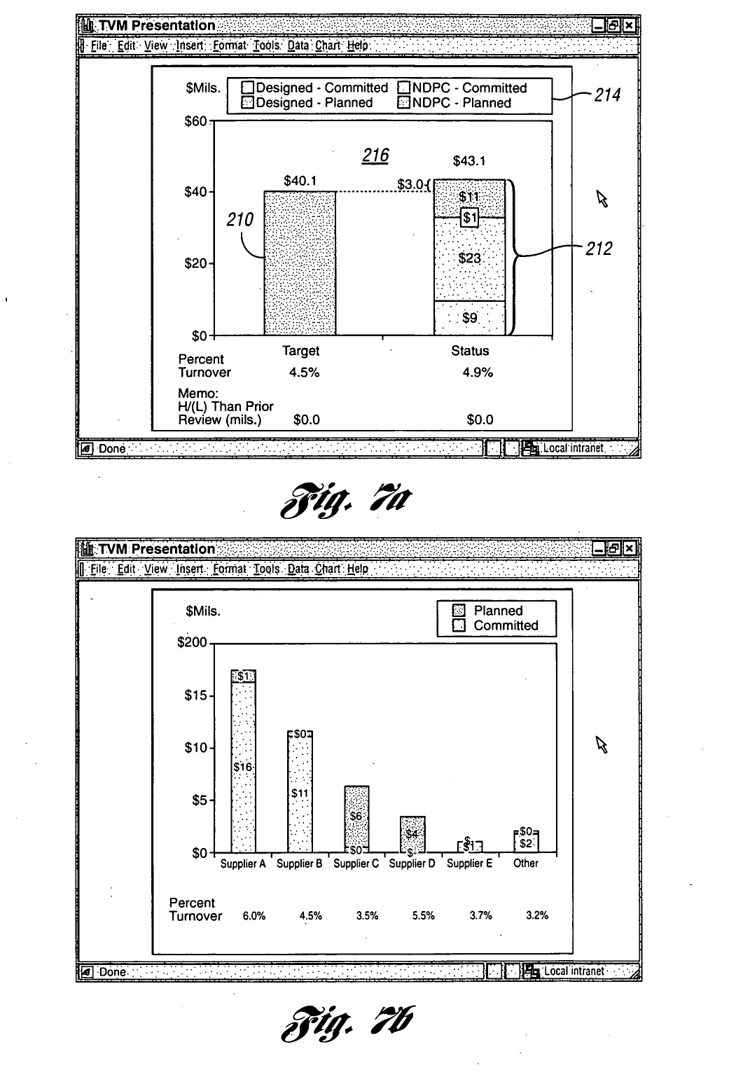

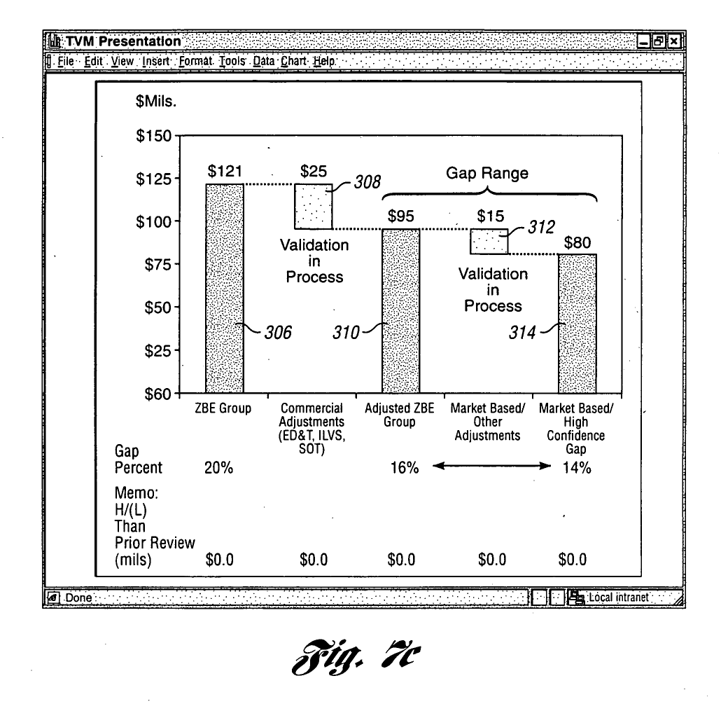

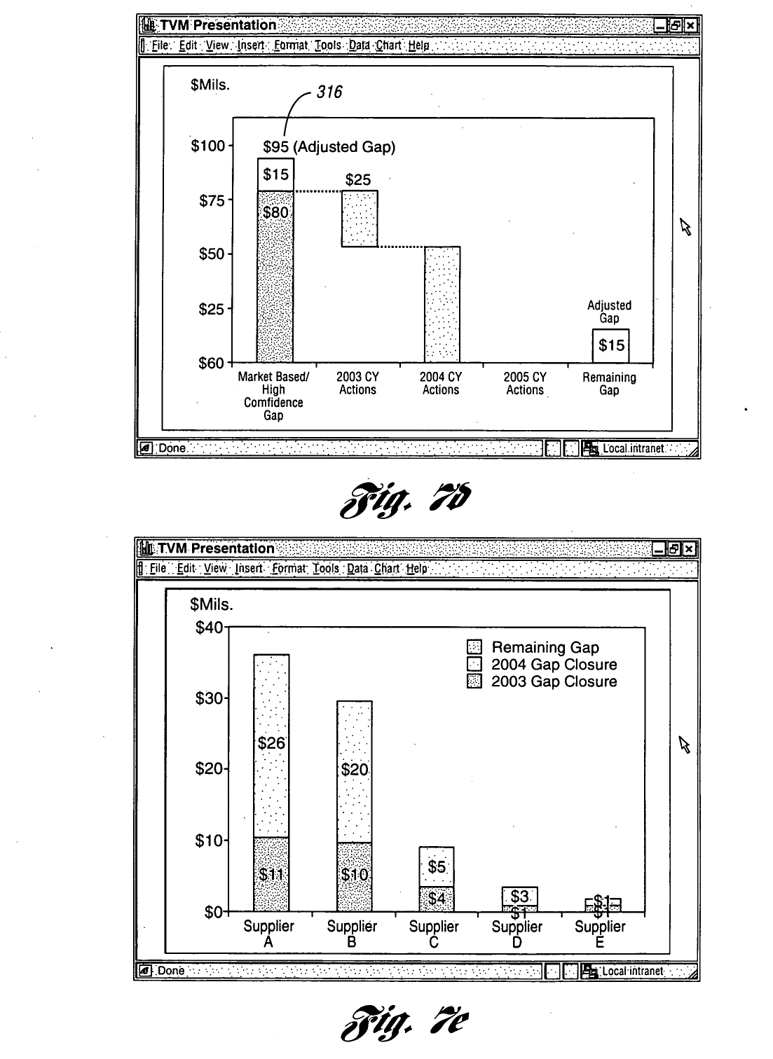

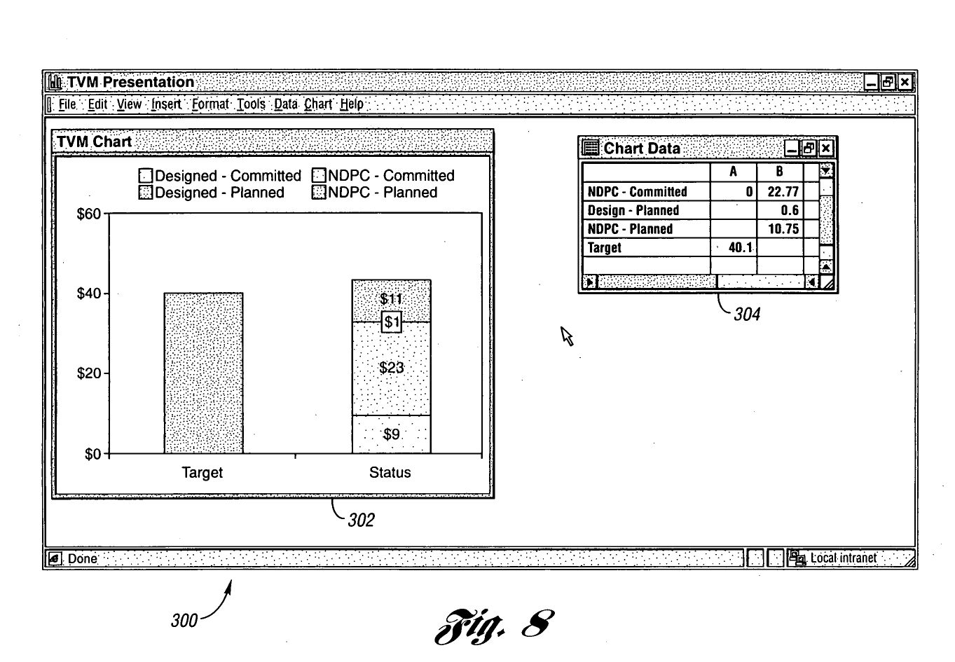

FIGS. 7a and 7b disclose application software interfaces for graphically comparing the current status of TVM cost-reduction progress with target progress milestones. FIG. 7a displays a graphical comparison between the target variance reduction for a calendar year 210 (e.g. $40.1 million), and a current variance reduction 212 (e.g. $43.1 million). In this example, the target variance reduction has been exceeded by $3.0 million for the current model year. Legend 214 provides a break-down of the target and current variance reduction opportunities (e.g., committed product design changes, planned product design changes, committed non-design price changes, planned non-design price changes, etc.). Preferably, a percentage of total turnover for the target and current variance reduction is automatically calculated and displayed.

Region 216 is configured in an interactive fashion such that, upon being selected by a user, a form for displaying, inputting or revising underlying variance data is automatically presented. One example of this aspect of the present invention is illustrated in FIG. 8, with reference to FIG. 7a in particular.

Referring to FIG. 8, GUI 300 comprises a chart window 302 and a data window 304. Revisions to data at window 304 are automatically reflected in chart 302 and corresponding interactive region 216 shown in FIG. 7a. A similar arrangement may be provided for generating or modifying the zero-based estimate displayed in FIG. 6 and the various graphs or charts described below (e.g. FIGS. 7b through 7e).

Regarding another aspect of the TVM technology, FIG. 7b graphically displays the respective cost impact of planned and committed variance reduction opportunities for a commodity by supplier for a given calendar year.

In a similar fashion, another interactive TVM interface (FIG. 7c) calculates and displays a commercial variance breakdown for a commodity. The variance to the zero-based estimate or gap 306 (e.g. $121 million) is reduced by current commercial adjustments 308 (e.g., cost elements in piece price but not in ZBE: $25 million, etc.) to calculate and display an adjusted zero-based estimate variance or gap 310 (e.g. $95 million). Adjusted zero-based estimate variance or gap 310 is then reduced by market-based adjustments 312 (e.g. $15 million) to arrive at a market based high-confidence variance or gap 314 (e.g. $80 million).

FIG. 7d graphically displays the quantitative impact of future variance reducing activities over future calendar years (e.g. 2004 through 2005) as projected against the current market based high-confidence variance or gap 316 (e.g. $95 million).

FIG. 7e graphically displays the quantitative impact of zero-based estimate variance or gap closure actions as projected across future years by supplier.

While the best mode for carrying out the invention has been described in detail, those familiar with the art to which this invention relates will recognize various alternative designs and embodiments for practicing the invention as defined by the following claims.

What is claimed:

1. A computer-implemented method for commodity value management in vehicle manufacturing, the method comprising:
receiving into one or more computer databases data representing a plurality of cost factors associated with supplying a commodity for vehicle manufacturing;
calculating a zero-based cost estimate for the commodity based on one or more of the plurality of cost factors;
receiving into the one or more computer databases a current cost for the commodity;
calculating a cost variance between the current cost for the commodity and the zero-based cost estimate;
receiving into one or more of the computer databases one or more actions for reducing the cost variance; and
displaying on one or more user interfaces the zero-based cost estimate for the commodity, the current cost for the commodity, the cost variance, and the one or more actions for reducing the cost variance.

2. The method of claim 1 wherein the one or more actions for reducing the cost variance includes supplier price negotiation.

3. The method of claim 1 wherein the one or more actions for reducing the cost variance includes supplier process improvement.

4. The method of claim 1 wherein the one or more actions for reducing the cost variance includes changing the design of the commodity.

5. The method of claim 1 additionally comprising implementing one or more of the actions for reducing the cost variance.

6. The method of claim 5 additionally comprising:
receiving into one or more of the computer databases a revised current cost for the commodity after the one or more actions for reducing the cost variance have been implemented;
calculating a revised cost variance between the revised cost for the commodity and the zero-based cost estimate; and
displaying the zero-based cost estimate for the commodity, the revised current cost for the commodity, and the revised cost variance.

7. The method of claim 1 wherein the zero-based cost estimate is calculated based on one or more best-in-class cost factors.

8. The method of claim 1 wherein the one or more user interfaces includes a chart displaying the zero-based estimate, the current cost for the commodity, and the cost variance.

9. The method of claim 8 wherein the chart includes one or more user-selectable regions, the selection of which causes a region for receiving user-defined commodity cost data to be automatically displayed.

10. The method of claim 1 additionally comprising receiving data representing a target commodity cost wherein the target commodity cost is also displayed on the one or more user interfaces.

11. The method of claim 1 wherein the cost factors include supplier manufacturing data.

12. The method of claim 1 wherein the cost factors include competitive benchmark data.

13. The method of claim 1 wherein the cost factors include market analysis data.

14. The method of claim 1 wherein a cross-functional team implements the methodology.

15. The method of claim 13 wherein the cross-functional team comprises one or more engineering representatives, one or more purchasing representatives, and one or more finance representatives.

16. The method of claim 13 wherein the cross-functional team comprises one or more engineering representatives, one or more cost estimators, and one or more purchasing representatives.

17. A computer system for commodity value management in vehicle manufacturing, the system comprising one or more computers programmed and configured to:
receive into one or more computer databases data representing a plurality of cost factors associated with supplying a commodity for vehicle manufacturing;
calculate a zero-based cost estimate for the commodity based on one or more of the plurality of cost factors;
receive into the one or more computer databases a current cost for the commodity;
calculate a cost variance between the current cost for the commodity and the zero-based cost estimate;
receive into one or more of the computer databases one or more actions for reducing the cost variance; and
display on one or more user interfaces the zero-based cost estimate for the commodity, the current cost for the commodity, the cost variance, and the one or more actions for reducing the cost variance.

18. The system of claim 17 wherein the one or more computers are additionally programmed and configured to:
receive into one or more of the computer databases a revised current cost for the commodity after the one or more actions for reducing the cost variance have been implemented;
calculate a revised cost variance between the revised cost for the commodity and the zero-based cost estimate; and
display the zero-based cost estimate for the commodity, the revised current cost for the commodity, and the revised cost variance.

19. The system of claim 17 wherein the zero-based cost estimate is calculated based on one or more best-in-class cost factors.

20. The system of claim 17 wherein the display includes a chart displaying the zero-based estimate, the current cost for the commodity, and the cost variance.

21. The system of claim 23 wherein the chart includes one or more user-selectable regions, the selection of which results in a region for receiving user-defined commodity cost data to be automatically displayed.

22. The system of claim 17 wherein the one or more computers are additionally programmed and configured to receive data representing a target commodity cost and display the target commodity cost.

23. A method for commodity value management in vehicle manufacturing, the method comprising:
a step for establishing a cost benchmark for a commodity for vehicle manufacturing;
a step for setting a cost target for the commodity;
a step for defining one or more actions for reaching the cost target; and
a step for implementing the one or more actions for reaching the cost target.

24. The method of claim 23 wherein the commodity is for a future vehicle that has not been manufactured.
